(19) United States
(12) Patent Application Publication
(10) Pub. No.: US 2010/0057691 A1
(43) Pub. Date: Mar. 4, 2010

(54) Method, server extensionand database management system for storing annotations of non-XML documents in an XML database

(75) Inventors: Julius Geppert, Darmstadt (DE); Michael Gesmann, Darmstadt (DE)

Correspondence Address: NIXON & VANDERHYE, PC, 901 NORTH GLEBE ROAD, 11TH FLOOR, ARLINGTON, VA, 22203, US

(73) Assignee: SOFTWARE AG, Darmstadt (DE)

(21) Appl. No.: 12/292,147

(22) Filed: Nov. 12, 2008

(30) Foreign Application Priority Data
Sep. 3, 2008 (EP) 08 015 542.7

(51) Int. Cl. G06F 17/30; G06F 7/00

(52) U.S. Cl. 707/3; 707/100; 707/E17.008; 707/E17.014; 707/E17.044

(57) ABSTRACT

The present invention relates to a method for storing annotations of non-XML documents (10) in an XML database (1), the XML database (1) being adapted for storing a corresponding shadow XML document (20) for each of the non-XML documents (10), the method comprising the steps of:
a. receiving an annotation document (15) comprising the annotations and attaching the annotations to the corresponding shadow XML document (20) in the XML database (1); and
b. receiving an updated non-XML document (10′) and attaching any existing annotations from the original shadow XML document (20) to an updated shadow XML document (20′) created by the XML database (1).

### 1. TECHNICAL FIELD

The present invention relates to a method, a server extension and a database management system for the annotation of non-XML documents in an XML database.

### 2. THE PRIOR ART

XML databases are one of the most important technical tools of modern information societies. The high degree of flexibility of such databases allows to store and to retrieve data in a highly efficient manner. Generally, XML databases are designed for XML documents. However, in the prior art it is also known to extend is an XML database so that it is capable to store other types of documents. For example the XML database Tamino of applicant is adapted to store non-XML documents such as plain text files, MS Office files, PDF files, images, video and audio files, etc. To enable the future retrieval of such non-XML documents from the database, it is known to analyze any non-XML document to be stored and to extract metadata for generating a so-called shadow document corresponding to the non-XML document (see FIG. 1). Using XQuery, such shadow XML documents can later be searched and the corresponding non-XML document can be retrieved. Another example for the above described approach is the TeXtML, server of ixiasoft in cooperation with Stellent Software.

While the above described metadata is preferably automatically extracted from the non-XML document, it may be desired to further add user-defined metadata, so called user-annotations. The annotation of non-XML documents with user-defined metadata is increasingly popular e.g. in photo or video sharing platforms on the internet, where users may add user-defined “tags” to photos and videos. In the prior art, such user-annotations are typically added to the shadow XML documents.

For example the U.S. Pat. No. 6,549,922 B1 discloses an extensible framework for the automatic extraction of metadata from media files. The extracted metadata may be combined with additional metadata from sources external to the media files and the combined metadata is stored in an XML database together with the original media file.

The US 2005/0050086 A1 describes a multimedia object retrieval apparatus and method for retrieving multimedia objects from structured documents containing both a multimedia object and relevant explanation text.

Furthermore, a media system is disclosed in the US 2003/0105743 A1 which includes a store of individual files of media content and a separate repository of related meta-information, as well as a query interface to search for media files in a database.

However, none of the prior art approaches addresses the task of maintaining existing user-annotations when updating the non-XML documents in an XML database. When a non-XML document is updated, i.e. the non-XML document is replaced by a new version in the XML database, the automatically generated meta-data is typically calculated anew and the original shadow XML document is overwritten with the new metadata. However, the existing user-annotations are lost in this process.

It is therefore the technical problem underlying the present invention to provide an approach which allows for the annotation of non-XML documents in XML databases in an integrated manner so that the annotations survive updates of the non-XML documents, thereby at least partly overcoming the disadvantages of the prior art.

### 3. SUMMARY OF THE INVENTION

In one aspect of the present invention, this problem is solved by a method for storing annotations of non-XML documents in an XML database, the XML database being adapted for storing a corresponding shadow XML document for each of the non-XML documents. In the embodiment of claim 1, the method comprises the steps of:
a. receiving an annotation document comprising the annotations and attaching the annotations to the corresponding shadow XML document in the XML database; and
b. receiving an updated non-XML document and attaching any existing annotations from the original shadow XML document to an updated shadow XML document created by the XML database.

Accordingly, when annotating a non-XML document, the XML database receives an annotation document comprising the annotations and the annotations are attached to the corresponding shadow XML document in the XML database. When the non-XML document is updated in a later stage, i.e. a new version of the non-XML document is stored and thus the corresponding shadow XML document is generated anew by the XML database, any existing annotations from the original version of the non-XML document are attached to the newly created shadow XML document. This allows for existing annotations to “survive” the update of the corresponding non-XML document, so that no annotations are lost when the XML database re-generates the shadow XML document.

In one aspect, step a. may comprise merging the annotation document with the corresponding shadow XML document and storing the merged shadow XML document in the XML database. The merging may e.g. be performed by a join query. Alternatively, step a. may comprise storing the annotation document in the XML database and storing a reference to the annotation document in the corresponding shadow XML document. Thus, the XML database may store the original non-XML document, the corresponding shadow XML document and the annotation document, wherein the annotation document is linked to the corresponding shadow XML document by a reference.

In another aspect of the invention, step a may be performed together with the processing of the non-XML document by the XML database in a single store request. This allows for passing user annotations directly when storing new non-XML documents in the XML database.

Furthermore, step a. may comprise overwriting any existing annotations of the corresponding shadow XML document. When receiving new annotations for a non-XML document whose shadow XML document already has annotations attached in the XML database, the old annotations are preferably replaced with the new annotations.

Additionally or alternatively, the method may comprise the step of updating the annotations attached to the corresponding shadow XML document. The updating may e.g. be performed by an XQuery update. It should be appreciated that the annotations can be obviously updated regardless of whether they are stored in annotation documents separate from the shadow documents in the XML database or whether they are merged into the shadow documents.

In yet another aspect of the invention, the shadow XML document conforms to a schema and the schema defines a name of an annotation root element. The schema may further define allowed sub-elements of the annotation root element for storing the annotations from the corresponding annotation document. Furthermore, the step b. may comprise searching for existing annotations within the sub-elements of the annotation root element in the shadow XML document. Accordingly, the shadow XML document may comprise a special root element whose children store the annotations from the annotation document. This root element as well as the structure of its sub-elements may be defined by a schema. When an updated non-XML document is received, the original shadow XML document may be searched, preferably by an XQuery, in order to retrieve any existing annotations and attach them to the newly created shadow XML document.

The XML database may also be adapted for storing both non-XML documents and XML documents.

The present invention also relates to a server extension for storing annotations of non-XML documents in an XML database, the XML database being adapted for storing a corresponding shadow XML document for each of the non-XML documents, the server extension being adapted to perform any of the above methods. Such a server extension may be part of a larger database management system (DBMS).

Finally, a computer program is provided comprising instructions adapted to perform any of the described methods.

### 4. SHORT DESCRIPTION OF THE DRAWINGS

In the following detailed description, presently preferred embodiments of the invention are further described with reference to the following figures:

FIG. 1: A schematic representation of an XML database system for storing non-XML documents according to the prior art;

FIG. 2: A schematic representation of an XML database system for storing non-XML documents and user-annotations according to an embodiment of the present invention;

FIG. 3: A schematic representation of storing an updated non-XML document in an XML database system according to an embodiment of the present invention;

FIG. 4: An exemplary shadow XML document created by an XML database system according to an embodiment of the present invention;

FIG. 5: An exemplary annotation document according to an embodiment of the present invention;

FIG. 6: An exemplary shadow XML document with attached annotations according to an embodiment of the present invention;

FIG. 7: An exemplary shadow XML document with updated annotations according to an embodiment of the present invention; and

FIG. 8: An exemplary schema definition of a shadow document according to an embodiment of the present invention.

### 5. DETAILED DESCRIPTION OF PREFERRED EMBODIMENTS

In the following, exemplary embodiments of the method of the present invention are described. It will be understood that the functionality described below can be implemented in a number of alternative ways, e.g. on a single database, in a distributed arrangement of a plurality of databases, with an integral storage or an external storage, etc. None of these implementation details are essential for the present invention.

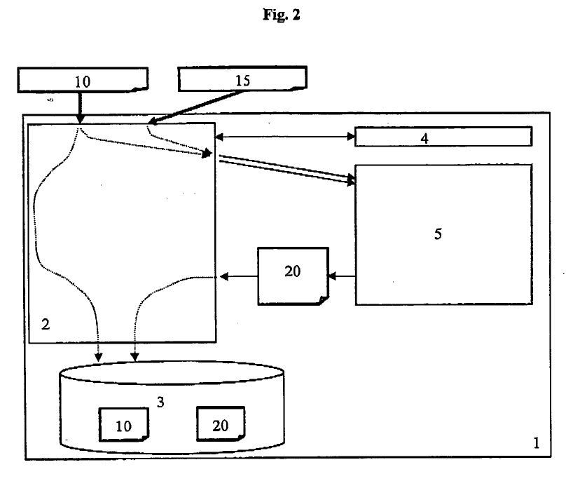

FIG. 2 presents an overview of an exemplary XML database system 1. The XML database system 1 generally serves to store and to retrieve XML documents (not shown in FIG. 2). However, the XML database system 1 is also capable to process non-XML documents such as the exemplary file 10. The file 10 can be any type of non-XML document, e.g. a text file in any kind of format (Word, PDF), a video file, an audio file, a combination thereof, an image, an arbitrary set of binary data such as measurement results, etc. Furthermore, an annotation document 15 is provided which comprises a number of user-annotations, i.e. custom metadata which is preferably not automatically derivable from the file 10.

For processing the file 10 and the annotation document 15, the XML database system 1 comprises in one embodiment a document processor 2. The document processor 2 drives the process for storing a document. As illustrated by the dotted arrow on the left side of FIG. 2, the file 10 is stored in the storage means 3, for example a RAID array (not shown) or a similar storage device of the XML data base system 1. Any volatile or non-volatile storage means known to the person skilled in the art can be used as the storage means 3 of the XML database system 1.

In addition, the file 10 is forwarded to a schema processor 4. The operation of the schema processor 4 and the further elements of the XML database system 1 which are shown on the right side of FIG. 2 serves to process the file 10 so that it can be searched and retrieved similar to other XML documents stored in the database. In the exemplary embodiment of FIG. 2, the schema processor 4 provides information about a server extension 5 to be called. It is to be noted that the server extension 5 could also be integrated into the standard processing engine of a database server of the overall XML database system and does not have to be provided as a separate entity. However, the provision of a separate server extension 5 facilitates the upgrading of an existing XML database system with the functionality for the handling of non-XML files and user-annotations, such as the file 10 and the annotation document 15.

The server extension 5 processes the file 10 and generates content for a shadow XML document 20. Depending on the type of file 10, different steps can be performed to generate the shadow XML document 20. For example, image processing on an image file 10 may be performed leading to an output of metadata about the image such as its resolution, color distribution or any other type of image related information. Other types of non-XML files may be processed similarly to generate any kind of metadata for the shadow XML document 20. Using the shadow XML document 20, a search can be performed, which allows to quickly retrieve the corresponding non-XML file 10 from the database.

Additionally, the contents of the annotation document 15 may in one embodiment be directly embedded into the generated shadow XML document 20, e.g. in that the server extension 5 performs a join operation on the shadow XML document 20 and the annotation document 15. The resulting annotated shadow XML document 20 may then be stored in the storage means 3 for later retrieval. In alternative embodiments, the annotation document 15 may be stored separately in the storage means 3 and a reference to the annotation document 15 may be inserted into the generated shadow XML document 20.

A presently preferred embodiment of the above explained XML database system is available from applicant under the name Tamino. The server extension of the Tamino database system of applicant is called Tamino Non-XML Indexer. It integrates non-XML documents, for example Microsoft Office documents or Adobe PDF documents, into the Tamino database system. When a non-XML document is stored or updated in a Tamino database collection in which the Tamino Non-XML Indexer is active, Tamino stores two objects, namely the non-XML document itself comprising the “raw data” as well as its annotated shadow document comprising the metadata extracted from the file (e.g. the plain ASCII text in a Microsoft Word file) and preferably the custom metadata given by the annotation document, as described above.

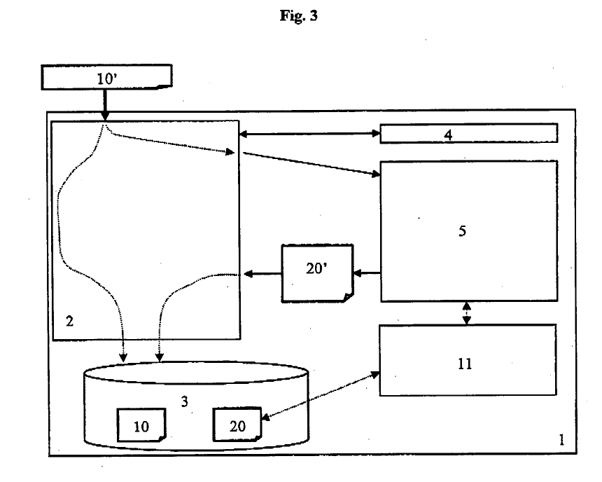

Furthermore, a preferred embodiment of the present invention allows for maintaining user annotations even when the corresponding file, i.e. the non-XML document 10, is updated. FIG. 3 shows a file 10′, which is a new version of the file 10 already stored in the XML database 1. It is supposed to replace the original file 10, e.g. because a new version of an image with better quality is supposed to replace the original low-quality version stored in the XML database system 1. To this end, existing annotations are first searched, i.e. the shadow XML document 20 corresponding to the original file 10 already stored in the storage means 3 is inspected to determine if it already has annotations attached. This step is preferably performed by a query processor 11 of the XML database system 1. When the server extension 5 subsequently generates a new shadow XML document 20′ based on the file 10′, any existing annotations are attached to the new shadow XML document 20′, so that the existing annotations are preserved although the corresponding file 10 has been updated.

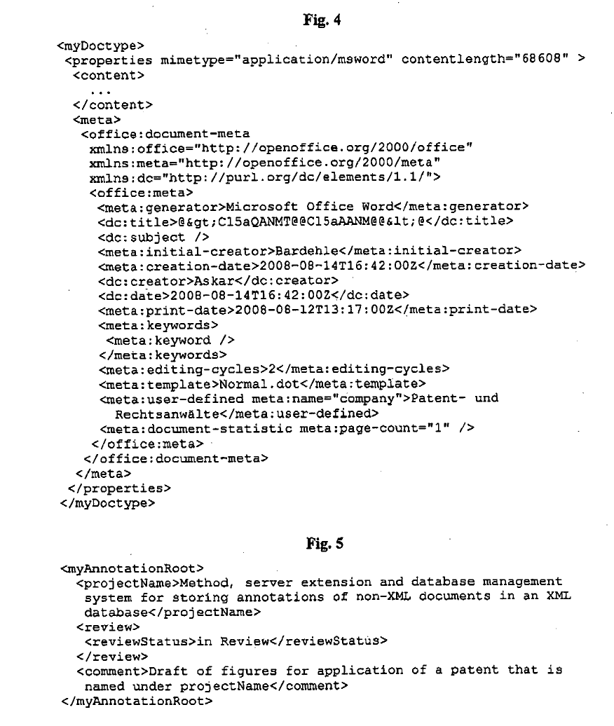

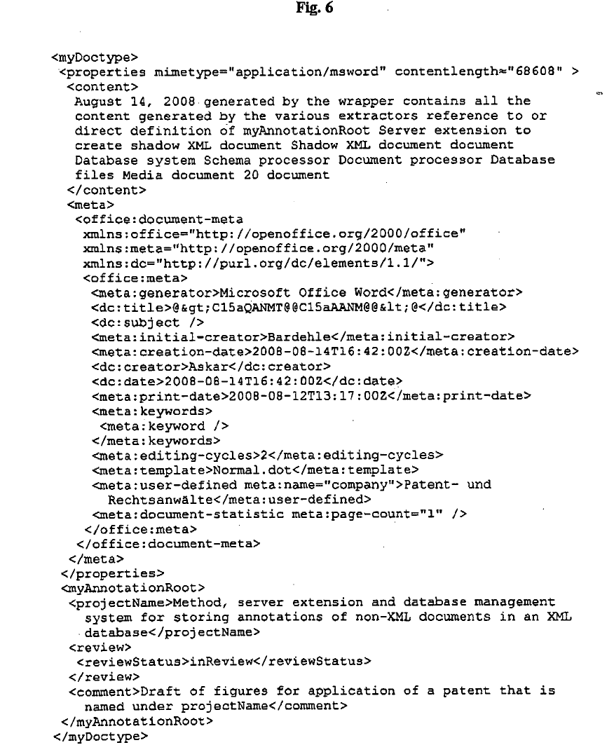

The operations performed by the XML database system 1 are in the following illustrated by a concrete example, wherein a text document 10 is edited by multiple authors and annotated with information about its status in a review process. First, the document 10 is to be initially stored along with user-annotations in the XML database system 1. Therefore, the exemplary shadow XML document 20 shown in FIG. 4 is created from the document 10. The exemplary shadow XML document 20 comprises automatically generated meta-data such as the creator, the creation date, etc. (see FIG. 4, page 4, lines 12-29) and the extracted text of the file 10 (not shown in FIG. 4).

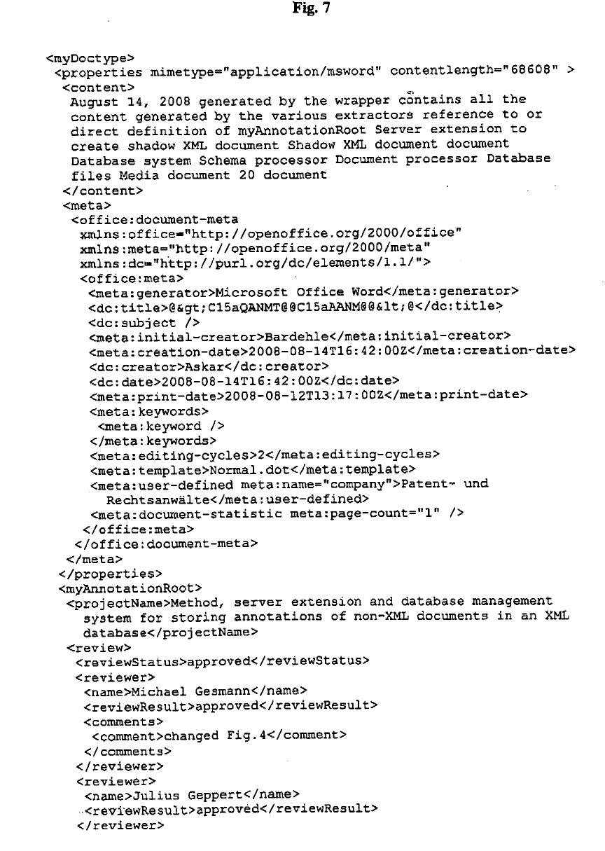

The store request also comprises the exemplary annotation document 15 shown in FIG. 5, which comprises user-defined annotations like the project name, the review status of the document and a comment. In order to distinguish the annotation document 15 from an ordinary XML document to be stored, a special keyword like e.g. “_ANNOTATION” might be provided in the database interface. According to a preferred embodiment of the present invention, when storing the document 10, the annotations from the annotation document 15 are incorporated in the generated shadow XML document 20 in order to produce the annotated shadow XML document 20 shown in FIG. 6. As can be seen, this document comprises all the information of the original shadow XML document (from FIG. 4) as well as the annotation information (see FIG. 6, page 5, lines 39-48).

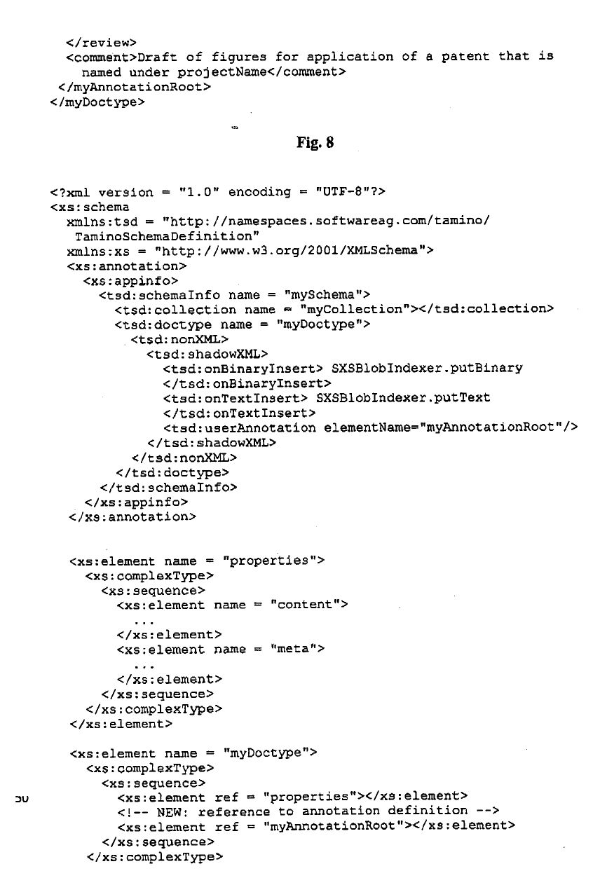

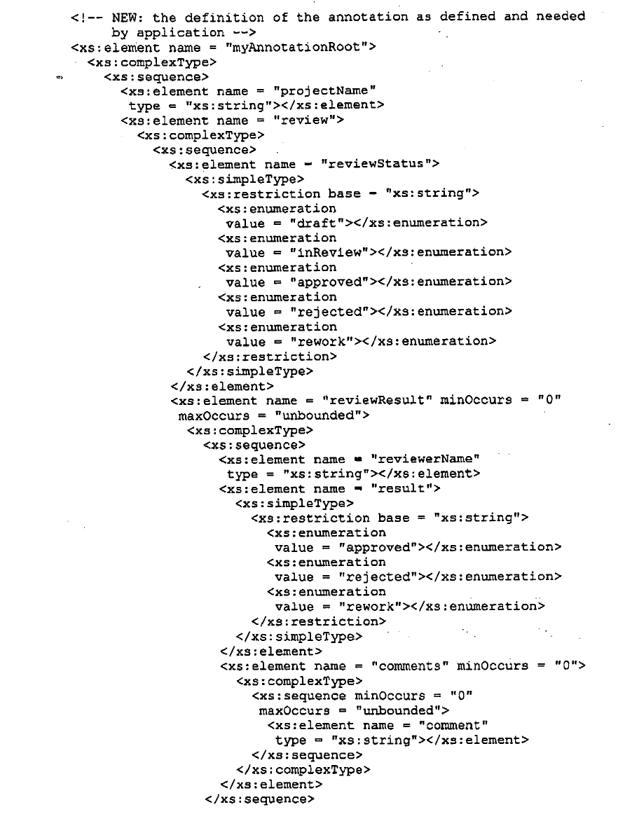

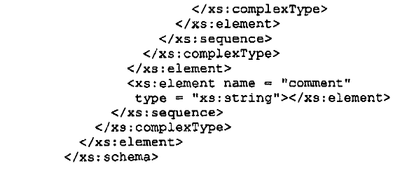

The exemplary shadow XML document 20 in the example (from FIGS. 4 and 6) conforms to a schema definition depicted in FIG. 8. The exemplary schema definition comprises a number of special elements (e.g. <tsd:onBinaryIsert> and <tsd:onTextInsert>) for instructing the schema processor 4 how to process the document 10. Furthermore, the schema definition in FIG. 8 comprises an element <tsd:userAnntation> which defines a name (“myAnnotationRoot” in the example) for the root element of annotation elements which are supposed to be attached to shadow XML documents conforming to this schema. This name definition indicates that shadow XML documents that conform to the schema may comprise annotations in child-elements of an element of the defined name. How the annotations are structured may also be defined in the schema. As can be seen from the example in FIG. 8, an annotation of type “myAnnotationRoot” may comprise, among others, elements “projectName”, “review”, “reviewStatus” etc., wherein “reviewStatus”-elements are restricted to the values “draft”, “in Review”, “approved”, “rejected” and “rework”.

When the server extension 5 processes the document 10 and the annotation document 15, it may first create the new shadow XML document 20 based on the schema definition. As the exemplary schema definition in FIG. 8 shows, such a shadow XML document 20 comprises an element <myDoctype> as root element. The server extension 5 then inserts the generated metadata from the file 10 under the <myDoctype> element and further inserts the annotations from the annotation document 15 into a <myAnnotationRoot> element. As already described above, the user-annotations, i.e. the contents of the annotation document 15 may alternatively be separately stored in the XML database system 1 and be referenced from the shadow XML document 20.

When the review process of the document is finished, the document 10 may be updated in the XML database system 1, i.e. it may be replaced with the final version 10′ of the document. To this end, the existing annotations are first retrieved from the original shadow XML document 20 preferably by an XQuery like the following example, where $inoId identifies the document 10 to be updated:

for $x in collection (“myCollection”)/myDoctype
where tf:getInoId($x)=$inoId
return Sx/myAnnotationRoot

The retrieved annotations are then attached to the newly created shadow XML document 20′. As can be seen from FIG. 8, the annotation information is preferably generated and maintained as immediate children under the <myDoctype> root element. It should be appreciated that “myDoctype” and “myAnnotationRoot” in FIG. 8 are only exemplary names of schema elements and that any meaningful names may be chosen in specific schema definitions.

Also, after the final version of the document 10 has been stored, the annotations may be updated to represent the new (final) review status. This may e.g. be performed by standard XQuery updates of the annotated shadow XML document 20, which results in the updated shadow XML document 20 shown in FIG. 7. As can be seen, the review status has been set to “approved” (see FIG. 7, page 6, line 44).

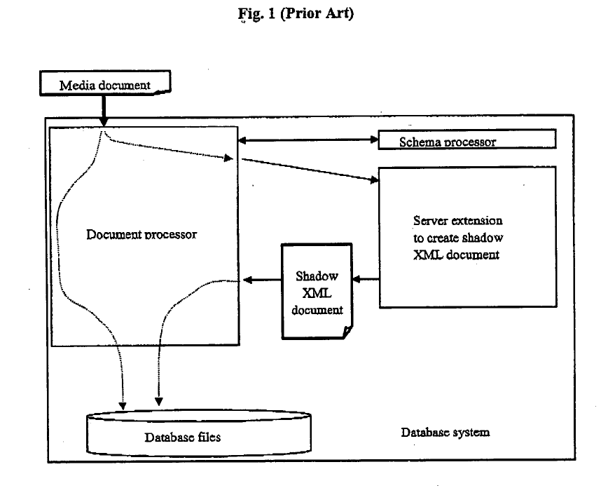

In summary the following cases are distinguished by the server extension 5 according to an embodiment of the present invention when receiving a non-XML document 10 with annotations:
When a new/updated non-XML document 10 is received together with an annotation document 15, and there are no annotations present in the XML database system 1, the annotations from the annotation document 15 are attached to the shadow XML document 20.
When a new/updated non-XML document 10 is received without an annotation document 15, and there already are annotations present in the XML database system 1, the existing annotations are attached to the shadow XML document 20.
When a new/updated non-XML document 10 is received without an annotation document 15, and there are no annotations present in the XML database system 1, the server extension 5 stores the non-XML document according to the prior art (see FIG. 1).
When a new/updated non-XML document 10 is received together with an annotation document 15, and there already are annotations present in the XML database system 1, the annotations from the annotation document 15 are attached to the shadow XML document 20 and the existing annotations are preferably overwritten.

As FIG. 2 indicates, when storing a new non-XML document in the database system 1, the document processor 2 preferably receives the input file 10 and the annotation document 15 in order to incorporate the user-annotations into the shadow XML file 20 in a single step. However, this is not a necessity. Alternative embodiments may as well first store the file 10 separately and later attach the user-annotations.

1. Method for storing annotations of non-XML documents (10) in an XML database (1), the XML database (1) being adapted for storing a corresponding shadow XML document (20) for each of the non-XML documents (10), the method comprising the steps of:
a. receiving an annotation document (15) comprising the annotations and attaching the annotations to the corresponding shadow XML document (20) in the XML database (1); and
b. receiving an updated non-XML document (10′) and attaching any existing annotations from the original shadow XML document (20) to an updated shadow XML document (20′) created by the XML database (1).

2. Method of claim 1, wherein step a. comprises merging the annotation document (15) with the corresponding shadow XML document (20) and storing the merged shadow XML document (20) in the XML database (1).

3. Method of claim 1, wherein step a. comprises storing the annotation document (15) in the XML database (1) and storing a reference to the annotation document (15) in the corresponding shadow XML document (20).

4. Method of claim 1, wherein step a. is performed together with the processing of the non-XML document (10) by the XML database (1) in a single store request.

5. Method of claim 1, wherein step a. comprises overwriting any existing annotations of the corresponding shadow XML document (20).

6. Method of claim 1, further comprising the step of updating the annotations attached to the corresponding shadow XML document (20).

7. Method of claim 6, wherein the updating is performed by an XQuery update.

8. Method of claim 1, wherein the shadow XML document (20) conforms to a schema and the schema defines a name of an annotation root element.

9. Method of claim 8, wherein the schema defines allowed sub-elements of the annotation root element for storing the annotations from the corresponding annotation document (15).

10. Method of claim 8, wherein step b. comprises searching for existing annotations within the sub-elements of the annotation root element in the shadow XML document (20).

11. Method of claim 10, wherein the searching is performed by an XQuery.

12. Method of claim 1, wherein the XML database (1) is adapted for storing non-XML documents (10) and XML documents.

13. Server extension (5) for storing annotations of non-XML documents (10) in an XML database (1), the XML database (1) being adapted for storing a corresponding shadow XML document (20) for each of the non-XML documents (10), the server extension (5) being adapted to perform a method of claim 1.

14. Database management system comprising a server extension (5) according to claim 13.

15. Computer program comprising instructions adapted to perform a method of claim 1.
